(19) United States
(12) Patent Application Publication
(10) Pub. No.: US 2014/0362864 A1
(43) Pub. Date: Dec. 11, 2014

(54) TRANSMITTING APPARATUS, TRANSMITTING METHOD, AND STORAGE MEDIUM

(71) Applicant: CANON KABUSHIKI KAISHA, Tokyo (JP)

(72) Inventor: Shun Sugimoto, Tokyo (JP)

(21) Appl. No.: 14/297,238

(22) Filed: Jun. 5, 2014

(30) Foreign Application Priority Data
Jun. 11, 2013 (JP) 2013-122940

(51) Int. Cl. H04L 12/707

(52) U.S. Cl. CPC H04L 45/24
USPC 370/400

(57) ABSTRACT

Reduction of the processing cost of reconstructing data at a receiving apparatus in multipath transmission is aimed at. A transmitting apparatus for transmitting data using a plurality of communication paths includes a determination unit configured to determine whether to cause a communication path for transmitting a first data unit and a communication path for transmitting a second data unit to be different, or to transmit a third data unit including the first data unit and the second data unit through one communication path among the plurality of communication paths, and a transmitting unit configured to transmit data included in the third data unit through a communication path determined by the determination unit.

### BACKGROUND OF THE INVENTION

1. Field of the Invention

The present invention relates to a transmitting apparatus, a transmitting method, and a storage medium storing a program to perform the transmitting method.

2. Description of the Related Art

Presently, media transport using an IP (Internet Protocol) network such as the Internet is widely used. With media transport, media data such as a moving image or audio captured by a camera or the like may be transmitted in real time over a network. As such a protocol, RTP (A Transport Protocol for Real-Time Applications, RFC3550, IETF (Internet Engineering Task Force)) is used.

Also, with the resolution of moving images becoming more and more enhanced, there is a greater demand for an increased variety of media data in accordance with widespread use of smartphones and tablets. This, in turn, increases the need for a wider network band for media transport, and efficient use of a network band is desired together with infrastructure development.

As a method of efficiently using a network band, there is a multipath transmission technology that uses a plurality of available network interfaces in parallel, and that increases the capacity. As a protocol supporting the multipath transmission, there may be cited Multipath TCP (Architectural Guidelines for Multipath TCP Development, RFC6182, IETF). Also, other protocols include Multipath RTP and CMT-SCTP (Concurrent Multipath Transfer using Stream Control Transmission Protocol).

In the multipath transmission that uses a plurality of paths in parallel, it is conceivable that the bands or the jitters of the plurality of paths to be used are different. If a media data packet is transferred through a path with a narrow band and a great jitter, the delay until reception by a receiving apparatus is possibly greater than in a case where the media data packet is transferred through a path with a wide band and a small jitter. In this regard, Japanese Patent Application Laid-Open No. 2006-67075 discloses a technique of controlling the amount of data to be distributed to each path while taking into account the difference in the bands or the jitters of the paths.

In the multipath transmission, a receiving apparatus stores a media data packet received from each path in a packet buffer provided for each path. Then, the receiving apparatus reconstructs the data stored in the packet buffer of each path.

At this time, if highly related data packets are stored in different packet buffers, the processing cost for the reconstruction of data is increased. Accordingly, there is a problem that computer resources such as the CPU and a memory of the receiving apparatus are squeezed.

### SUMMARY OF THE INVENTION

The present invention has been made in view of the problem above, and is directed to reduce the processing cost of reconstructing data at a receiving apparatus in multipath transmission.

Accordingly, the present invention is characterized by a transmitting apparatus for transmitting data using a plurality of communication paths, the transmitting apparatus including a determination unit configured to determine whether to cause a communication path for transmitting a first data unit and a communication path for transmitting a second data unit to be different, or to transmit a third data unit including the first data unit and the second data unit through one communication path among the plurality of communication paths, and a transmitting unit configured to transmit data included in the third data unit through a communication path determined by the determination unit.

Further features of the present invention will become apparent from the following description of exemplary embodiments with reference to the attached drawings.

### BRIEF DESCRIPTION OF THE DRAWINGS

FIG. 1 is a diagram illustrating an example hardware configuration of transmitting apparatuses according to first and second embodiments.

FIG. 2 is a functional block diagram of the transmitting apparatuses according to the first and the second embodiments.

FIG. 3 is a diagram illustrating an example of the hierarchical structure of media data.

FIG. 4 is a flow chart illustrating a transmission process according to the first embodiment.

FIG. 5 is a flow chart illustrating a group assignment process.

FIG. 6A is a diagram illustrating an example configuration of transmission target media data.

FIG. 6B is a diagram for describing assignment of media data to a communication path.

FIG. 7 is a diagram illustrating an example of the degree of priority according to the second embodiment.

FIG. 8 is a flow chart illustrating a group assignment process according to the second embodiment.

FIG. 9 is a diagram for describing an example of a transmission process according to the second embodiment.

### DESCRIPTION OF THE EMBODIMENTS

Preferred embodiments of the present invention will now be described in detail in accordance with the accompanying drawings.

### First Embodiment

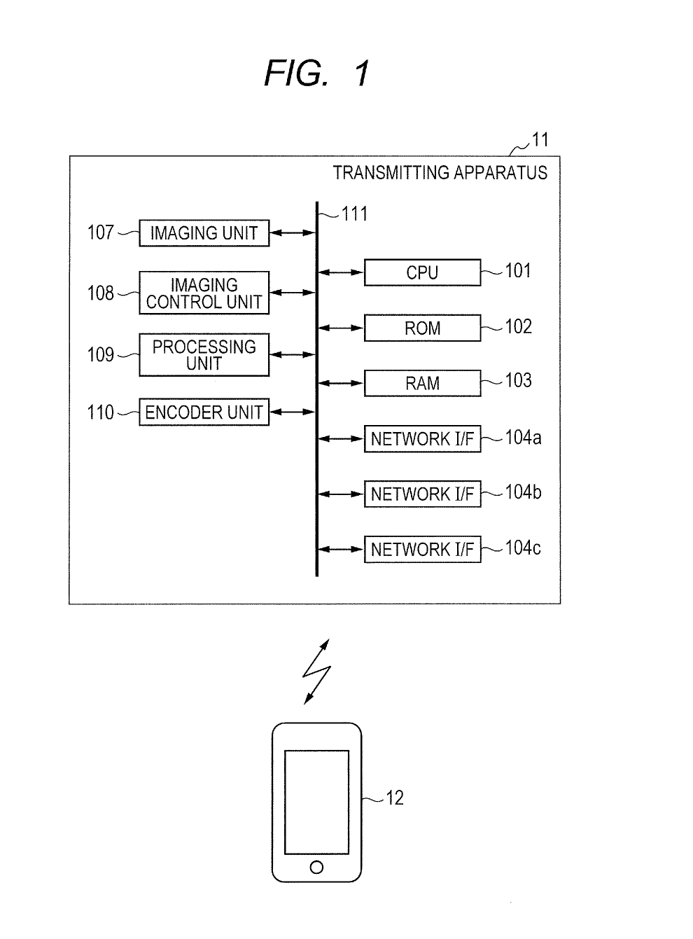

FIG. 1 is a diagram illustrating a hardware configuration of a transmitting apparatus 11. The transmitting apparatus 11 according to the present embodiment transmits media data in real time in units of packets by multipath transmission that uses a plurality of network interfaces in parallel. The transmitting apparatus 11 transmits, to a receiving apparatus 12, data such as an image or audio captured by a camera or the like as media data, for example. Additionally, the media data which is the transmission target of the transmitting apparatus 11 may include metadata, error correction code data, and the like.

The transmitting apparatus 11 and the receiving apparatus 12 may each be realized by a single computer apparatus, or the functions of each apparatus may be distributed across a plurality of computer apparatuses, and each apparatus may be realized by a plurality of computer apparatuses. In the case each apparatus is realized by a plurality of computer apparatuses, the computer apparatuses are connected by a LAN (local area network) or the like in a manner capable of communication with each other.

A CPU (central processing unit) 101 controls each unit of the transmitting apparatus 11 described later in an integrated way. A ROM (read only memory) 102 stores control programs and the like to be executed by the CPU 101. A RAM (random access memory) 103 functions as the main memory, the work area or the like of the CPU 101.

Network I/Fs 104a to 104c are interfaces capable of connecting to the Internet, a public wireless network, or a LAN. In the present embodiment, the transmitting apparatus 11 includes three network I/Fs 104a to 104c, but the number of the network I/Fs is not limited to that of the embodiment as long as two or more network I/Fs are provided to the transmitting apparatus 11.

An imaging unit 107 receives optical information of an object by a sensor (an image sensor). An imaging control unit 108 controls the imaging unit 107. The imaging control unit 108 controls panning, tilting, zooming or the like of the imaging unit 107, for example. The imaging control unit 108 also controls driving of a lens. A processing unit 109 performs various processes such as white balance processing, gamma processing and noise reduction processing on digital data that is generated by performing A/D conversion on data captured by the imaging unit 107.

An encoder unit 110 performs a process of converting the digital data according to a specific encoding method. The encoder unit 110 according to the present embodiment is assumed to perform encoding by HEVC (High Efficiency Video Coding). Additionally, the encoding method is not limited to that of the embodiment, and the encoder unit 110 may perform encoding by other encoding methods such as H.264/AVC (Advanced Video Coding). A bus 111 is a transmission path for various types of data.

Additionally, the function and the process of the transmitting apparatus 11 described later are realized by the CPU 101 reading programs stored in the ROM 102 or the like and executing the programs.

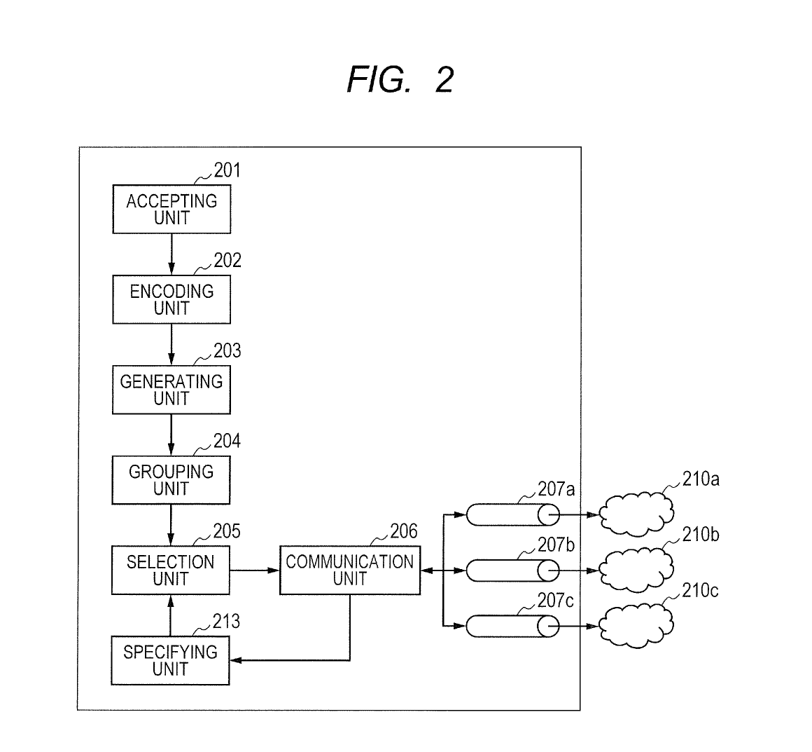

FIG. 2 is a diagram illustrating a software configuration of the transmitting apparatus 11. An accepting unit 201 accepts media data. The accepting unit 201 according to the present embodiment accepts media data captured by the imaging unit 107 onto which various processes have been performed by the processing unit 109.

An encoding unit 202 encodes the media data by an HEVC encoding method. A generating unit 203 packetizes the encoded media data according to a transmission protocol. Additionally, in the present embodiment, the transmission protocol is an RTP protocol, but this is not restrictive.

A grouping unit 204 defines a hierarchical structure of a group. Specifically, the grouping unit 204 groups (a grouping process) a plurality of packets configuring the media data in a plurality of different group units (granularity). The grouping unit 204 thereby obtains a plurality of hierarchical group sets.

Here, each of the plurality of group units is a hierarchical value, and is set in advance in the RAM 103, for example. Then, the grouping unit 204 groups the media data based on group units set in advance.

Also, each group set includes a plurality of groups. That is, a plurality of groups configuring a group set belongs to each hierarchy in the hierarchical structure. Additionally, the process of the grouping unit 204 will be described later in detail.

A selection unit 205 refers to the hierarchical structure defined by the grouping unit 204, and selects a hierarchy as a unit to be used at the time of assignment to each path, based on the communication state of each of the network I/Fs 104a to 104c. Here, the communication state is information indicating the use band of each path. The communication state is acquired from a specifying unit 213 described later.

The selection unit 205 selects, as processing targets, based on the communication state of each connection specified by the specifying unit 213, the network I/Fs 104a to 104c in order from the one for the connection of the best communication state. Then, the selection unit 205 selects a hierarchy for the selected one among the network I/Fs 104a to 104c.

With respect to the transmission function, a communication unit 206 stores packets in transmission queues 207a to 207c in the group unit of the hierarchy selected by the selection unit 205. Here, the transmission queues 207a to 207c are queues for packets waiting to be transmitted, corresponding to the network I/Fs 104a to 104c. The packets stored in the transmission queues 207a to 207c are transmitted to corresponding networks 210a to 210c in the order of storage in the transmission queues 207a to 207c.

Additionally, the networks 210a to 210c do not necessarily have to be completely different networks. It is sufficient if some of the networks are different among the networks 210a to 210c.

Also, with respect to a reception function, the communication unit 206 receives, from the receiving apparatus 12, information about the reception status. Then, the communication unit 206 sends the received information to the specifying unit 213.

The specifying unit 213 specifies, as the communication state, the band that can be used (available band) by each path. Specifically, the specifying unit 213 calculates the available band of each path corresponding to the network I/Fs 104a to 104c, based on the information received from the communication unit 206. For example, the specifying unit 213 calculates the available band by a calculation method according to TFRC (TCP Friendly Rate Control: Protocol Specification, RFC3448, IETF). Additionally, the specifying unit 213 may also calculate the available band by other methods.

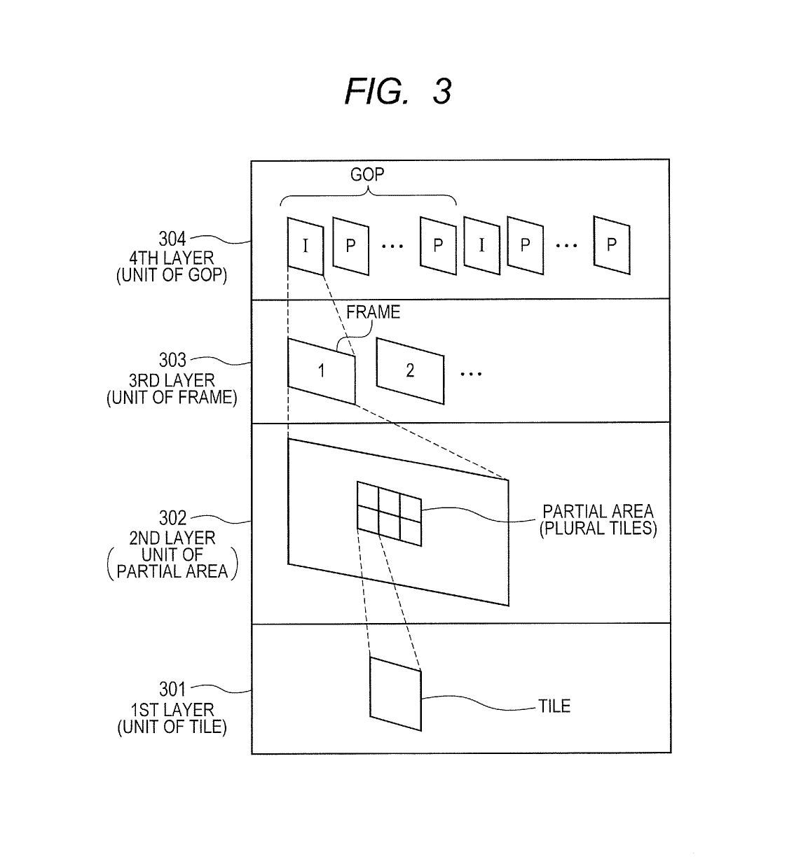

FIG. 3 is a diagram illustrating an example of the hierarchical structure of media data. The hierarchical structure illustrated in FIG. 3 illustrates the hierarchical structure of image data, as media data, encoded by HEVC. This hierarchical structure is defined by the grouping unit 204. The hierarchical structure illustrated in FIG. 3 includes four hierarchies 301 to 304. A layer is higher in the order a fourth layer 304, a third layer 303, a second layer 302, and a first layer 301 as the lowermost layer, where the fourth layer 304 is the uppermost layer.

One group set belongs to each of the hierarchies 301 to 304. Also, the group sets of the hierarchies 301 to 304 are different in the group unit of groups configuring each group set. More specifically, for example, the group unit of the group set belonging to the second layer 302 is an integer multiple of two or more of the group unit of the group set belonging to the first layer 301. Similarly, the group unit of each layer is an integer multiple of two or more of the group unit of a lower layer, and the plurality of hierarchies indicating the hierarchical structure have an inclusion relationship.

The group belonging to the first layer 301 takes the smallest data size in the hierarchical structure as the group unit. Specifically, with respect to the group belonging to the first layer 301, one rectangular block called a tile, which is a unit of encoding of HEVC, is taken as one group. Additionally, the size of the rectangle of the tile takes an arbitrary value. The grouping unit 204 groups a plurality of packets configuring media data in units of tiles in order from the headmost packet to thereby define the group set of the first layer 301.

The second layer 302 is a layer of groups where a partial area is taken as the group unit. A partial area is an area including a plurality of tiles defined in the first layer 301. In the example illustrated in FIG. 3, a partial area includes six tiles. The grouping unit 204 groups a plurality of packets configuring media data in units of partial areas in order from the headmost packet to thereby define the group set of the second layer 302.

The third layer 303 is a layer of groups where a frame of image data is taken as the group unit. The grouping unit 204 groups a plurality of packets configuring image data as media data in order from the headmost packet with the frame as the unit to thereby define the group set of the third layer 303.

Additionally, there are encoding methods, such as HEVC, according to which the data size varies greatly between an intra-encoded frame and an inter-encoded frame. In the case of taking media data encoded by such an encoding method as a target, the grouping unit 204 may group, in the third layer 303, the intra-encoded frames and the inter-encoded frames in different units. For example, the grouping unit 204 may take one intra-encoded frame as one group, or may define a plurality of inter-encoded frames as one group, in the third layer 303.

The fourth layer 304 is a layer of groups where a GOP (Group Of Pictures) is taken as the group unit. Here, the GOP includes a plurality of frames including at least one I picture. The grouping unit 204 groups a plurality of packets configuring image data in units of GOPs in order from the headmost packet to thereby define the group set of the fourth layer 304.

Additionally, the granularity (the unit of data size) of the group belonging to each hierarchy of the hierarchical structure is assumed to be stored in advance in a storage unit such as the RAM 103. With respect to the hierarchical structure illustrated in FIG. 3, the tile, the partial area, the frame, and the GOP are defined in the storage unit as the granularity of each hierarchy.

Additionally, the granularities of the hierarchical structure are not limited to those of the embodiment. Another example of the granularity may be a media unit where media data includes image data and audio data. Still another example of the granularity may be a hierarchical frame unit of SVC. Still another example of the granularity may be, in a case of transmitting media data to a plurality of apparatuses, in units of transmission destination apparatuses. Still another example of the granularity may be, in a case of transmitting a protection packet based on an error correcting code or a retransmission packet for an error loss, a set of media data and error correction code data. Also, the grouping unit 204 may take a retransmission packet as another group. Furthermore, the grouping unit 204 may define data combining a plurality of hierarchical granularities defined in advance as a new granularity.

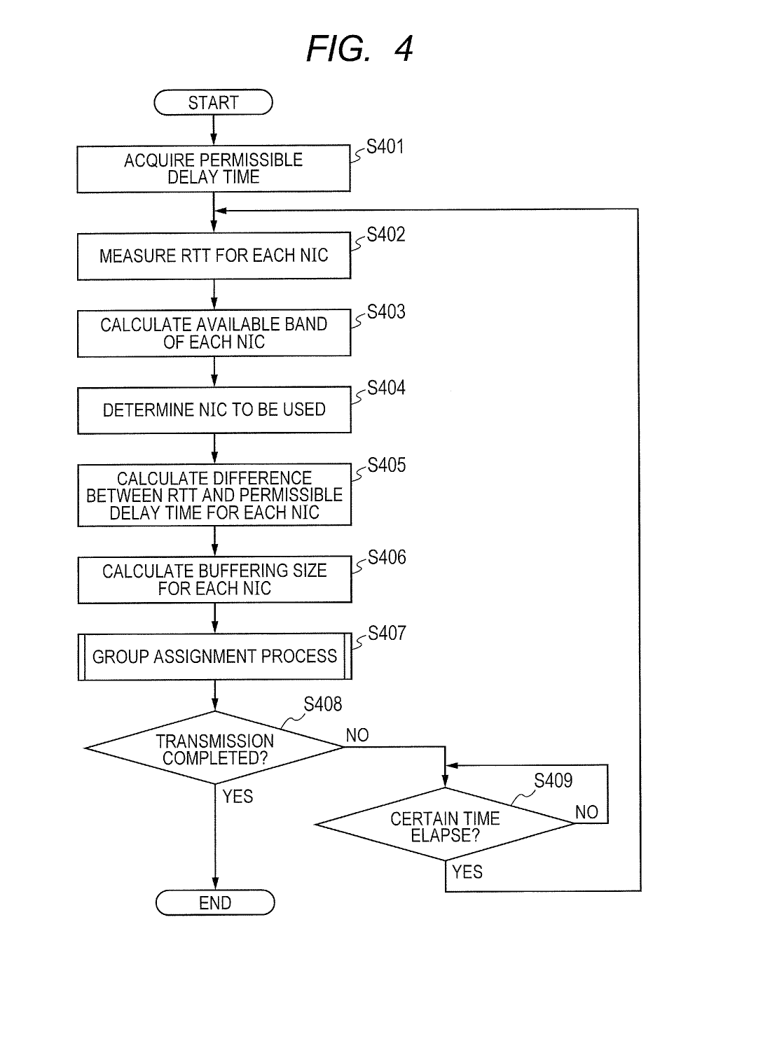

FIG. 4 is a flow chart illustrating a transmission process of the transmitting apparatus 11. In S401, the CPU 101 of the transmitting apparatus 11 acquires a permissible delay time. The permissible delay time here is the delay time that is permissible between a packet falling into a transmission wait state and reception of the packet by the receiving apparatus 12 which is the transmission destination of the packet.

The permissible delay time is determined at the transmitting apparatus 11, and is set in advance in the RAM 103 or the like of the transmitting apparatus 11. Additionally, the permission delay time is shorter for a system with a higher demand for real-timeness. Also, in another example, the permissible delay time may be set at the receiving apparatus 12. In this case, the CPU 101 acquires the permissible delay time from the receiving apparatus 12.

Next, in S402, the CPU 101 measures RTT (Round Trip Time) for each of the network I/Fs 104a to 104c. As the method of measuring the RTT, a method that uses ICMP (Internet Control Message Protocol) may be cited, but this is not restrictive. Additionally, in the following, the network I/Fs 104a to 104c will be referred to as NIC 1 to NIC 3, respectively, or simply as NIC(s).

Next, in S403, the CPU 101 calculates the available band of each NIC based on the RTT obtained for each NIC (NIC 1 to NIC 3). As the band calculation method, the TFRC mentioned above or the like may be cited.

Next, in S404, the CPU 101 determines the NIC to be used from among the NIC 1 to NIC 3 based on the available bands. For example, the CPU 101 is not to use an NIC whose available band falls below a threshold that is set in advance. Also, the CPU 101 may be such that an NIC is not used if there is a possible abnormality in the line to the NIC.

Next, in S405, the CPU 101 calculates the difference between the RTT and the permissible delay time for each of the NIC 1 to NIC 3. This difference means the maximum time when buffering in the transmission queues 207a to 207c corresponding to the NIC 1 to NIC 3, respectively, is allowed.

Then, in S406, the CPU 101 calculates the maximum value of the data size that can be buffered (the buffering size) in each of the transmission queues 207a to 207c. Specifically, the CPU 101 calculates the buffering size of each of the transmission queues 207a to 207c based on the available band of each of the NIC 1 to NIC 3 and the time obtained as the difference. The process in S406 is an example of a specifying process for specifying the maximum value as the communication state.

Next, in S407, the CPU 101 assigns, based on the buffering sizes, media data to the transmission queues 207a to 207c in group unit of one of the hierarchies. Additionally, the process in S407 will be described later in detail.

Then, in S408, the CPU 101 determines whether transmission of the media data is completed. In the case transmission of the media data is completed (Yes in S408), the CPU 101 ends the transmission process. In the case transmission of the media data is not completed (No in S408), the CPU 101 proceeds to S402 after a certain time has elapsed (Yes in S409).

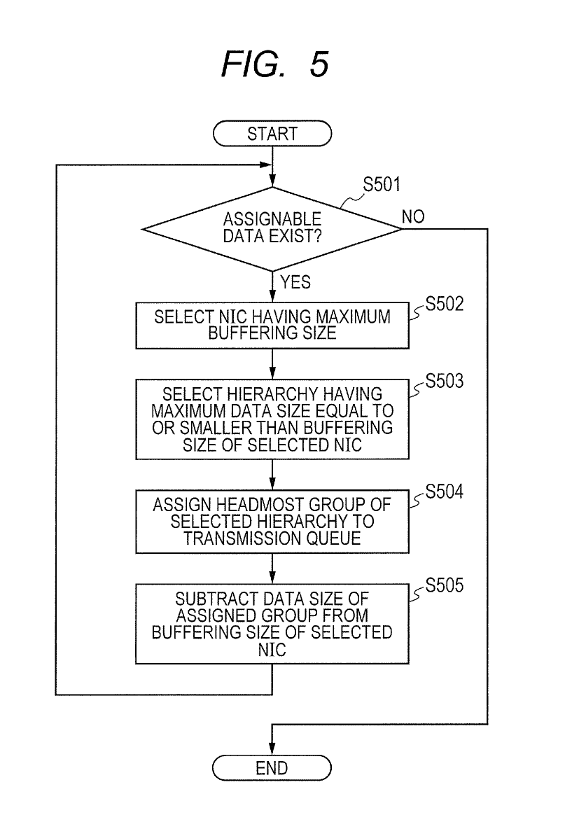

FIG. 5 is a flow chart illustrating a detailed process of the group assignment process (S407). Additionally, it is presupposed that a hierarchical structure having different group units as hierarchies is defined by the grouping unit 204 (the grouping process) before the group assignment process (S407) is started.

In S501, the CPU 101 checks whether or not there is assignable data. In the case assignable data exists (Yes in S501), the CPU 101 proceeds to S502. In the case assignable data does not exist (No in S501), the CPU 101 ends the group assignment process. Additionally, the CPU 101 determines that assignable data does not exist, in the case there is no data that is packetized and ready to be assigned. Also, the CPU 101 determines that assignable data does not exist, in the case the maximum values of the data size that can be buffered of all the NICs are smaller than the minimum value of the group unit of the media data.

Next, in S502, the CPU 101 selects, as a processing target, an NIC having the maximum buffering size from among all the NICs to be used. The buffering size of each NIC is the value calculated in S406. In the following, the NIC which is the processing target will be referred to as a target NIC.

Then, in S503, the CPU 101 specifies a group set (hierarchy) whose group unit has a data size equal to or smaller than the buffering size of the target NIC (i.e., equal to or smaller than the maximum value). Then, in the case there are several group sets which have been specified, the CPU 101 selects one group set with the largest group unit from among the specified group sets. The process in S503 here is an example of a selection process.

Next, in S504, the CPU 101 assigns, to the corresponding one of the transmission queues 207a to 207c of the target NIC, a headmost group which is not yet assigned among a plurality of groups of the selected group set. That is, the CPU 101 stores the headmost group in the corresponding one of the transmission queues 207a to 207c of the target NIC. The process in S504 here is an example of an assignment process of assigning a group to an NIC selected as a target communication path.

Next, in S505, the CPU 101 updates the buffering size of the target NIC. Specifically, the CPU 101 subtracts the data size of the group assigned in S504 from the buffering size of the target NIC, and takes the value obtained as a result of subtraction as the new buffering size of the target NIC. The CPU 101 repeats the processes from S502 to S505 until it is determined in S501 that assignable data does not exist.

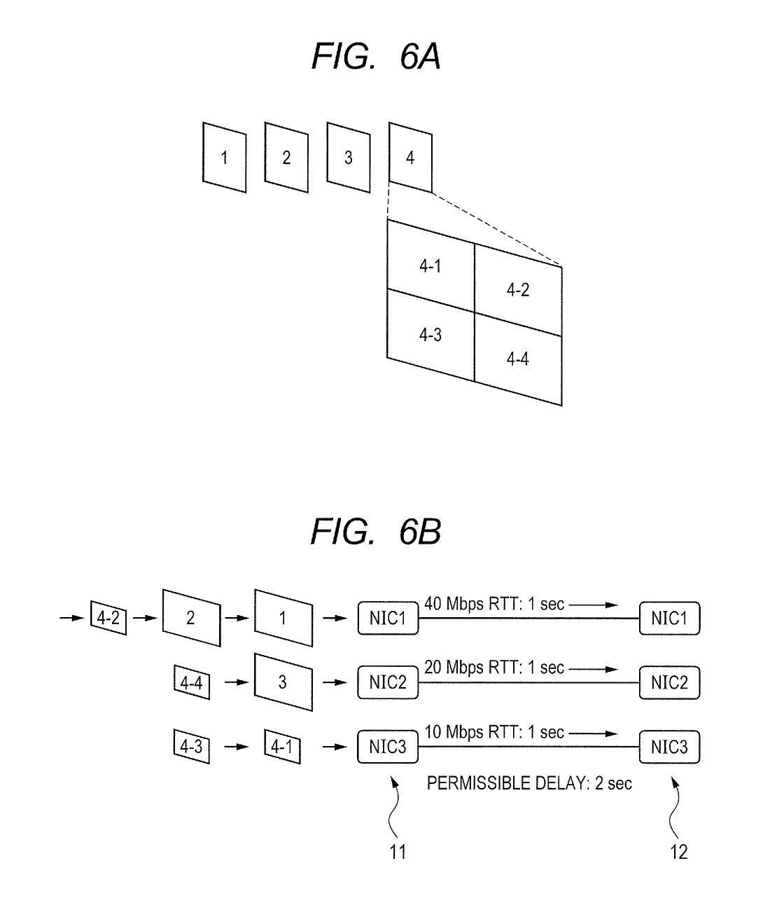

FIGS. 6A and 6B are diagrams for describing a transmission process. As illustrated in FIG. 6B, the transmitting apparatus 11 includes three network I/Fs 104a to 104c (NIC 1 to NIC 3). Also, the use bands of the NIC 1 to NIC 3 are 40 Mbps, 20 Mbps, and 10 Mbps, respectively. Furthermore, the RTTs of the paths corresponding to the NIC 1 to NIC 3 are all one second, and the permissible delay times are two seconds.

Additionally, the apparatus which is the transmission destination of media data, that is, the receiving apparatus 12, also includes three network I/Fs (NIC 1, NIC 2, NIC 3) in the same manner as the transmitting apparatus 11. The NIC 1 to NIC 3 of the transmitting apparatus 11 correspond to the NIC 1 to NIC 3 of the receiving apparatus 12, respectively.

Furthermore, for the sake of simplicity, the following condition is applied. That is, as illustrated in FIG. 6A, a hierarchical structure including two hierarchies, a group set in units of frames and a group set in units of partial areas, is defined. Here, the group set in units of frames is made the upper layer, and the group set in units of partial areas is made the lower layer.

Media data which is the processing target of the transmitting apparatus 11 is assumed to be image data including frames “1” to “4”, as illustrated in FIG. 6A. Also, each frame is assumed to be divided into four partial areas. Here, the partial areas of the frame 4 are referred to as partial areas “4-1” to “4-4”. The data size of the frames is 2 MB. The data size of the partial areas is 0.5 MB.

On the premises described above, the CPU 101 obtains, in S405, as the difference between the permissible delay time and the RTT of each of the NIC 1 to NIC 3, a value that is obtained by subtracting the RTT, one second, from the permissible delay time, two seconds, that is, one second.

Next, in S406, the CPU 101 obtains, with respect to the NIC 1, a buffering size of 5 MB (40 Mbps×1 second÷8 bits). Also, the CPU 101 obtains, with respect to the NIC 2, a buffering size of 2.5 MB (20 Mbps×1 second÷8 bits). Furthermore, the CPU 101 obtains, with respect to the NIC 3, a buffering size of 1.25 MB (10 Mbps×1 second÷8 bits).

Next, the group assignment process will be described. In S502, the CPU 101 selects, as the NIC having the maximum buffering size, the NIC 1 having the buffering size of 5 MB.

Here, a hierarchy having a buffering size equal to or smaller than the buffering size of the NIC 1 (5 MB) and having the largest group unit is the hierarchy (the upper layer) for the data set in units of frames (2 MB). Accordingly, in S503, the CPU 101 selects the hierarchy of units of frames. Then, in S504, the CPU 101 assigns the headmost frame of the media data, that is, the frame 1, to the transmission queue 207a of the NIC 1.

Then, in S505, the CPU 101 updates the buffering size of the NIC 1 to a value (3 MB) obtained by subtracting the data size of the frame 1 (2 MB) from 5 MB, and proceeds again to S501.

Subsequently, in S502, the CPU 101 compares the buffering size of the NIC 1 to NIC 3. Here, the NIC 1 having the buffering size of 3 MB is selected. The unit of frame (2 MB) is smaller than 3 MB. Accordingly, in S503, the CPU 101 selects the hierarchy having the frame as the group unit. Then, in S504, the CPU 101 assigns the frame 2 subsequent to the frame 1 to the transmission queue 207a of the NIC 1.

Next, in S505, the CPU 101 updates the buffering size of the NIC 1 to a value (1 MB) obtained by subtracting the data size of the frame 2 (2 MB) from 3 MB, and proceeds again to S501.

Then, in S502, the CPU 101 selects the NIC 2 having the buffering size of 2.5 MB as the NIC having the maximum buffering size. Subsequently, in S503, the CPU 101 selects the hierarchy having the frame as the group unit as the hierarchy of 2.5 MB or less and of the largest group unit. Then, in S504, the CPU 101 assigns the frame 3 subsequent to the frame 2 to the transmission queue 207b of the NIC 2.

Next, in S505, the CPU 101 updates the buffering size of the NIC 2 to a value (0.5 MB) obtained by subtracting the data size of the frame 3 (2 MB) from 2.5 MB, and proceeds again to S501.

Subsequently, in S502, the CPU 101 selects the NIC 3 having the buffering size of 1.25 MB as the NIC having the maximum buffering size. Here, 1.25 MB is smaller compared to the unit of frame (2 MB). Accordingly, in S503, the CPU 101 selects a lower layer of the hierarchy that takes the frame as the group unit, that is, a hierarchy that takes the partial area as the group unit. Then, in S504, the CPU 101 assigns the partial area 4-1 of the frame 4 subsequent to the frame 3 to the transmission queue 207c of the NIC 3.

As described above, the CPU 101 may assign the media data of frames 1 to 4 to the NIC 1 to NIC 3 as illustrated in FIG. 6B by repeating the processes of S501 to S505.

As described above, the transmitting apparatus 11 according to the present embodiment is capable of selecting one group unit from among different group units, based on the communication state of each of a plurality of communication paths, and of assigning transmission target data to each communication path in the selected group unit. Furthermore, data in a group unit at this time is continuous data which is a part of media data. Accordingly, the processing cost at the time of reconstructing the media data from data received in units of packets on the side of the receiving apparatus 12 may be reduced.

Moreover, the transmitting apparatus 11 may dynamically change the packet structure of a group to be assigned to each path. Accordingly, the transmitting apparatus 11 may efficiently use the band of each path.

As a first example modification of the first embodiment, the CPU 101 sequentially selects, in S504 (FIG. 5), groups from the beginning of media data, but the order of selection is not limited to be such.

Also, as a second example modification, the CPU 101 may obtain partial areas based on a focused area, instead of dividing into a predetermined number of tiles in order from the beginning of the frame and obtaining partial areas. For example, the CPU 101 may perform ranking with the focused area at the center, and arrange the partial areas in the order of rank. Furthermore, at the time of assignment to the transmission queues 207a to 207c (S505), the CPU 101 may preferentially assign a higher-ranking partial area to a path in a good state.

### Second Embodiment

Next, a transmitting apparatus 11 according to a second embodiment will be described. The transmitting apparatus 11 according to the second embodiment attaches the degree of priority to each of a plurality of groups included in the group set of a same hierarchy, and performs assignment to the transmission queues 207a to 207c based on the degree of priority. Additionally, here, portions different from the transmitting apparatus 11 according to the first embodiment will be described. In the second embodiment, an assignment process of groups (partial areas) belonging to a hierarchy of unit of partial area including at least one or more tiles according to HEVC will be described.

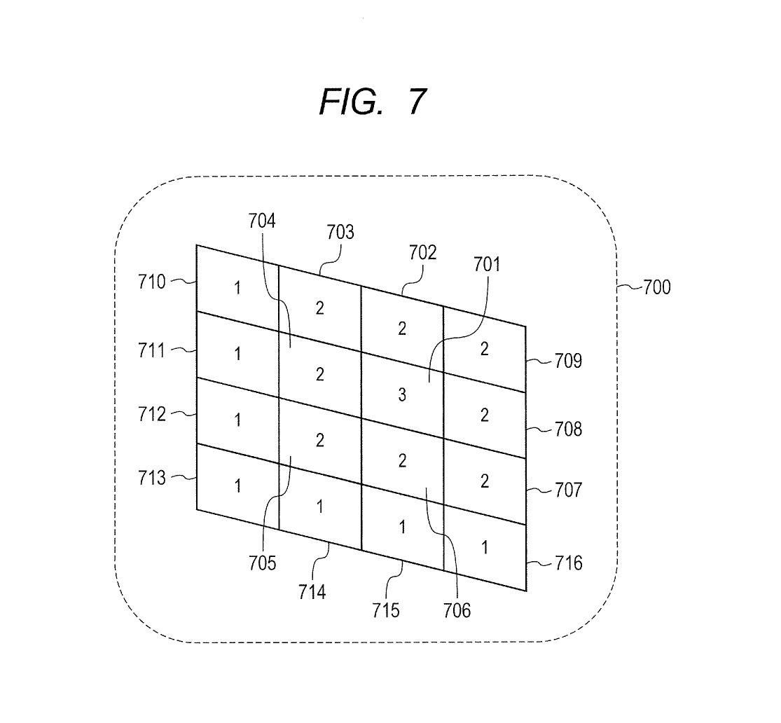

FIG. 7 is a diagram illustrating an example of the degree of priority. The degree of priority as illustrated in FIG. 7 is defined in each of partial areas 701 to 716 in a frame 700 illustrated in FIG. 7. That is, the degree of priority 3 is set in the partial area 701. The degree of priority 2 is set in the partial areas 702 to 707. The degree of priority 1 is set in the partial areas 708 to 716. Additionally, the degree of priority is assumed to be higher as the value of the degree of priority is greater.

For example, with respect to image data as media data, the CPU 101 attaches, in a frame, a higher degree of priority to an area attracting more attention from viewers. Specifically, the CPU 101 attaches a higher degree of priority to a partial area including motion compared to a partial area not including motion.

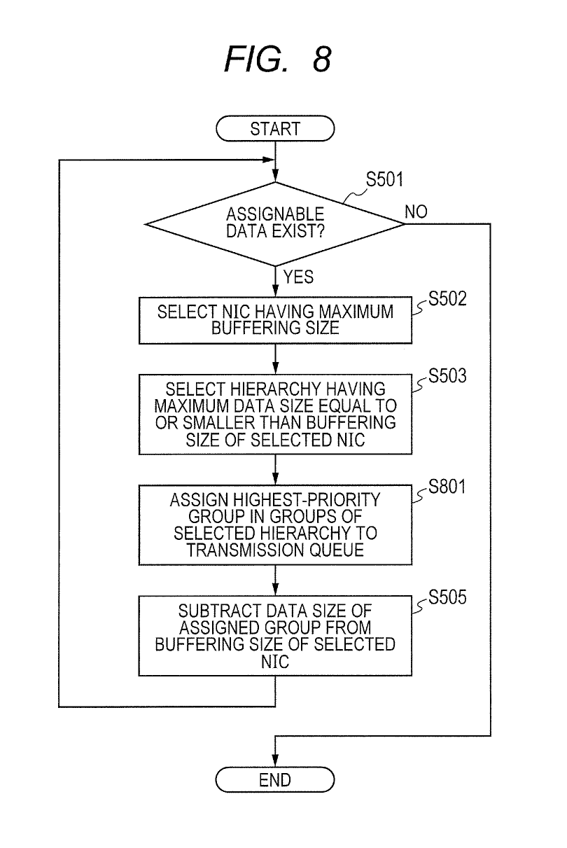

FIG. 8 is a flow chart illustrating a group assignment process by the transmitting apparatus 11 according to the second embodiment. The CPU 101 proceeds to S801 after selecting a hierarchy in S503. Then, in S801, the CPU 101 selects a group with the highest degree of priority from among a plurality of groups belonging to the selected hierarchy, and assigns the same to the transmission queue, among the transmission queues 207a to 207c, corresponding to the target NIC. Additionally, in the case there is only one group in S801, this group is assigned.

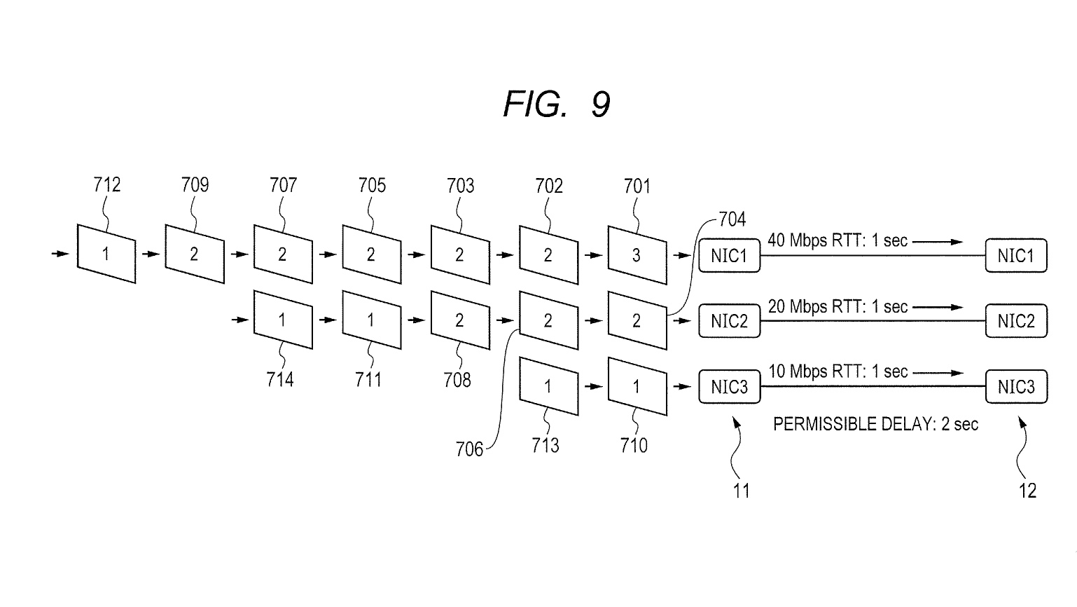

FIG. 9 is a diagram for describing a transmission process according to the second embodiment. As illustrated in FIG. 9, the transmitting apparatus 11 includes three network I/Fs 104a to 104c (NIC 1 to NIC 3). Also, the use bands of the NIC 1 to NIC 3 are 30 Mbps, 20 Mbps, and 10 Mbps, respectively.

Additionally, the apparatus which is the transmission destination of media data, that is, the receiving apparatus 12, also includes three network I/Fs (NIC 1, NIC 2, NIC 3) in the same manner as the transmitting apparatus 11. The NIC 1 to NIC 3 of the transmitting apparatus 11 correspond to the NIC 1 to NIC 3 of the receiving apparatus 12, respectively.

Furthermore, for the sake of simplicity, the following condition is applied. That is, as illustrated in FIG. 7, a frame that is encoded by HEVC is divided into 16 partial areas 701 to 716. Here, the data size of the partial areas 701 to 716 is 0.5 MB. Also, the data size of the entire frame is 8 MB (0.5 MB×16). The RTTs of the paths corresponding to the NIC 1 to NIC 3 are all one second, and the permissible delay times are two seconds.

In this case, in S406, the CPU 101 obtains, with respect to the NIC 1, a buffering size of 3.75 MB (30 Mbps×1 second÷8 bits). Also, the CPU 101 obtains, with respect to the NIC 2, a buffering size of 2.5 MB (20 Mbps×1 second÷8 bits). Furthermore, the CPU 101 obtains, with respect to the NIC 3, a buffering size of 1.25 MB (10 Mbps×1 second÷8 bits).

Next, the group assignment process will be described. In S502, the CPU 101 selects, as the NIC having the maximum buffering size, the NIC 1 having the buffering size of 3.75 MB. Next, in S503, the CPU 101 selects a hierarchy for the data set in units of partial areas (0.5 MB) as the hierarchy having a buffering size equal to or smaller than the buffering size of 3.75 MB of the NIC 1 and having the largest group unit.

Next, in S801, the CPU 101 selects the partial area 701 having the degree of priority 3 as the highest-priority group from among the groups of the selected hierarchy, and assigns the same to the transmission queue 207a of the NIC 1. Then, in S505, the CPU 101 updates the buffering size of the NIC 1 to a value obtained by subtracting the data size (0.5 MB) of the partial area 701 from 3.75 MB, and proceeds again to S501.

Subsequently, in S502, the CPU 101 compares the buffering size of the NIC 1, the NIC 2, and the NIC 3. Here, the NIC 1 having the buffering size of 3.25 MB is selected. Then, in S801, the CPU 101 selects the partial area 702 having the degree of priority 2 as the highest-priority group.

As described above, the CPU 101 may assign the partial areas 701 to 714 to the NIC 1 to NIC 3 in the manner illustrated in FIG. 9, by repeating the processes illustrated in FIG. 8. Additionally, the CPU 101 assigns the partial areas 715 and 716 to the NIC 1 to NIC 3 in the group unit of a hierarchy lower than the hierarchy taking the partial area as the group unit, that is, the group unit of the hierarchy taking the tile as the group unit.

Also, as another example, the CPU 101 may assign the partial areas 715 and 716 in the group assignment process that is performed next by taking the partial area as the group unit. As still another example, the CPU 101 may skip the assignment of the partial areas 715 and 716 because the degree of priority is low for the partial areas 715 and 716.

Additionally, other structures and processes of the transmitting apparatus 11 according to the second embodiment are the same as the structures and processes of the transmitting apparatus 11 according to the first embodiment.

As described above, the transmitting apparatus 11 of the second embodiment may preferentially assign a high-priority group to a communication path.

An example modification of the second embodiment will be described. The transmitting apparatus 11 may attach the degree of priority to the group of an arbitrary hierarchy in the hierarchical structure of media data. For example, the transmitting apparatus 11 may attach the degree of priority to the groups of all the hierarchies set in advance. Also, in another example, the transmitting apparatus 11 may attach the degree of priority to the group of only one or some hierarchies among a plurality of hierarchies of the hierarchical structure. The transmitting apparatus 11 may attach the degree of priority to the group of a hierarchy for the frame unit of SVC, for example. Moreover, in still another example, the transmitting apparatus 11 may define a frame and error correction code data for protecting the frame or retransmission data to be of the same hierarchy, and may attach the degree of priority to the group of this hierarchy.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiments of the present invention, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-122940, filed Jun. 11, 2013, which is hereby incorporated by reference herein in its entirety.

What is claimed is:

1. A transmitting apparatus for transmitting data using a plurality of communication paths, the transmitting apparatus comprising:
a determination unit configured to determine whether to cause a communication path for transmitting a first data unit and a communication path for transmitting a second data unit to be different, or to transmit a third data unit including the first data unit and the second data unit through one communication path among the plurality of communication paths; and
a transmitting unit configured to transmit data included in the third data unit through a communication path determined by the determination unit.

2. The transmitting apparatus according to claim 1, further comprising:
a specifying unit configured to specify a data size that is assignable to each communication path based on a band that is available to the each communication path,
wherein the transmitting unit transmits, through a first communication path among the plurality of communication paths, a data unit having a data size smaller than a data size that is assignable to the first communication path.

3. The transmitting apparatus according to claim 1, further comprising:
a specifying unit configured to specify a second communication path to which a maximum data size is assignable, among each data size that is assignable to each of the plurality of communication paths,
wherein, in a case where a data size of the third data unit is equal to or smaller than the maximum data size, the transmitting unit transmits the third data unit through the second communication path, and, in a case where the data size of the third data unit is larger than the maximum data size, the transmitting unit causes the communication path for transmitting the first data unit and the communication path for transmitting the second data unit to be different.

4. The transmitting apparatus according to claim 1, further comprising:
a specifying unit configured to specify a second communication path to which a maximum data size is assignable, among each data size that is assignable to each of the plurality of communication paths,
wherein, in a case where a data size of the third data unit is larger than the maximum data size, the transmitting unit transmits the second data unit for which a higher degree of priority than the first data unit is set in advance through the second communication path.

5. The transmitting apparatus according to claim 1, further comprising:
an acquisition unit configured to acquire the first data unit and the second data unit by dividing transmission data to be transmitted by the transmitting unit based on a first division unit, and for acquiring the third data unit by dividing the transmission data based on a second division unit.

6. A control method of a transmitting apparatus for transmitting data using a plurality of communication paths, the control method comprising:
determining whether to cause a communication path for transmitting a first data unit and a communication path for transmitting a second data unit to be different, or to transmit a third data unit including the first data unit and the second data unit through one communication path among the plurality of communication paths; and
transmitting data included in the third data unit through a communication path determined in the determining.

7. The control method according to claim 6, further comprising:
specifying a data size that is assignable to each communication path based on a band that is available to the each communication path,
wherein, transmitting, through a first communication path among the plurality of communication paths, a data unit having a data size smaller than a data size that is assignable to the first communication path.

8. The control method according to claim 6, further comprising:
specifying a second communication path to which a maximum data size is assignable, among each data size that is assignable to each of the plurality of communication paths,
wherein, in the transmitting, in a case where a data size of the third data unit is equal to or smaller than the maximum data size, the third data unit is transmitted through the second communication path, and, in a case where the data size of the third data unit is larger than the maximum data size, the communication path for transmitting the first data unit and the communication path for transmitting the second data unit are caused to be different.

9. The control method according to claim 6, further comprising:
specifying a second communication path to which a maximum data size is assignable, among each data size that is assignable to each of the plurality of communication paths,
wherein, in the transmitting, in a case where a data size of the third data unit is larger than the maximum data size, the second data unit for which a higher degree of priority than the first data unit is set in advance is transmitted through the second communication path.

10. The control method according to claim 6, further comprising:
acquiring the first data unit and the second data unit by dividing transmission data to be transmitted in the transmitting based on a first division unit, and acquiring the third data unit by dividing the transmission data based on a second division unit.

11. A non-transitory computer-readable storage medium which stores a program for causing a computer of transmitting data using a plurality of communication paths to perform:
a determination procedure for determining whether to cause a communication path for transmitting a first data unit and a communication path for transmitting a second data unit to be different, or to transmit a third data unit including the first data unit and the second data unit through one communication path among the plurality of communication paths; and
a transmitting procedure for transmitting data included in the third data unit through a communication path determined in the determination procedure.

12. The storage medium according to claim 11, wherein the program further causes the computer to perform:
a specifying procedure for specifying a data size that is assignable to each communication path based on a band that is available to the each communication path,
wherein, transmitting, through a first communication path among the plurality of communication paths, a data unit having a data size smaller than a data size that is assignable to the first communication path.

13. The storage medium according to claim 11, wherein the program further causes the computer to perform:
a specifying procedure for specifying a second communication path to which a maximum data size is assignable, among each data size that is assignable to each of the plurality of communication paths,
wherein, in the transmission procedure, in a case where a data size of the third data unit is equal to or smaller than the maximum data size, the third data unit is transmitted through the second communication path, and, in a case where the data size of the third data unit is larger than the maximum data size, the communication path for transmitting the first data unit and the communication path for transmitting the second data unit are caused to be different.

14. The storage medium according to claim 11, wherein the program further causes the computer to perform:
a specifying procedure for specifying a second communication path to which a maximum data size is assignable, among each data size that is assignable to each of the plurality of communication paths,
wherein, in the transmission procedure, in a case where a data size of the third data unit is larger than the maximum data size, the second data unit for which a higher degree of priority than the first data unit is set in advance is transmitted through the second communication path.

15. The storage medium according to claim 11, wherein the program further causes the computer to perform:
an acquisition procedure for acquiring the first data unit and the second data unit by dividing transmission data to be transmitted in the transmission procedure based on a first division unit, and acquiring the third data unit by dividing the transmission data based on a second division unit.
